(19) United States
(12) Patent Application Publication
(10) Pub. No.: US 2025/0259476 A1
(43) Pub. Date: Aug. 14, 2025

(54) INFORMATION PROCESSING APPARATUS, METHOD OF CONTROLLING THE SAME, AND STORAGE MEDIUM

(71) Applicant: CANON KABUSHIKI KAISHA, Tokyo (JP)

(72) Inventor: KOJI MAKITA, Kanagawa (JP)

(21) Appl. No.: 19/047,124

(22) Filed: Feb. 6, 2025

(30) Foreign Application Priority Data
Feb. 8, 2024 (JP) 2024-018130

(51) Int. Cl. G06V 40/16; G06V 40/40; G06V 40/60

(52) U.S. Cl. CPC G06V 40/172; G06V 40/40; G06V 40/67

(57) ABSTRACT

An information processing apparatus includes an acquisition unit that acquires a face image of the target person, a face authentication unit that performs face authentication of the target person by using the face image, an operation instruction unit that issues an instruction to the target person to perform an operation while holding the information processing apparatus, an operation authentication unit that performs operation authentication of the target person based on the operation being performed according to the issued instruction and an actual operation including positional movement of the information processing apparatus, and a determination unit that determines that the authentication of the target person has succeeded when the face authentication has succeeded and the operation authentication has succeeded, and determines that the authentication of the target person has failed when at least one of the face authentication and the operation authentication has failed.

### BACKGROUND

### Field

The present disclosure relates to an information processing apparatus for performing face authentication, a method of controlling the information processing apparatus, and a storage medium.

### Description of the Related Art

In a face authentication system using a camera mounted on a portable terminal apparatus, a face image previously authenticated and registered and a face image of an authentication target person acquired with the camera are compared to determine whether the authentication target person present in front of the camera at the moment is the person with the registered face image. Such authentication is highly convenient because the authentication is completed only by imaging a face with the camera, and is applicable to, for example, electronic Know Your Customer (eKYC), attendance checking of a class in school and the like, and a roll call at a work site.

However, since the authentication target person performs the face authentication processing while holding the terminal apparatus by himself/herself, the authentication target person hardly receives attention from those around him/her. Thus, as compared with a face authentication system using a fixed-point camera, there is an issue that spoofing using a face photograph of a different person and the like is easily performable.

As a method of detecting spoofing, there is a known method in which it is determined whether a face present in front of the camera has a flat shape, and in a case where the face present in front of the camera has a flat shape, it is determined that spoofing using a photograph, a display of another terminal apparatus, or the like is performed. Japanese Patent Application Laid-Open No. 2019-204358 discusses a technique for analyzing whether a face has a flat shape based on a relationship between an angle of the camera and a camera image captured, thereby determining an improper operation such as spoofing.

### SUMMARY

According to an aspect of the present disclosure, an information processing apparatus that performs authentication of a target person includes at least one memory storing instructions, and at least one processor that, upon execution of the stored instructions, causes the information processing apparatus to function as an acquisition unit that acquires a face image of the target person, a face authentication unit that performs face authentication of the target person by using the face image, an operation instruction unit that issues an instruction to the target person to perform an operation while holding the information processing apparatus, an operation authentication unit that performs operation authentication of the target person based on the operation being performed according to the issued instruction and an actual operation of the information processing apparatus, including positional movement of the information processing apparatus, and a determination unit that determines that the authentication of the target person has succeeded when the face authentication has succeeded and the operation authentication has succeeded, and determines that the authentication of the target person has failed when at least one of the face authentication and the operation authentication has failed.

Further features of the present disclosure will become apparent from the following description of exemplary embodiments with reference to the attached drawings.

### BRIEF DESCRIPTION OF THE DRAWINGS

FIG. 1 is a diagram illustrating an example of an appearance of an information processing apparatus.

FIG. 2 is a diagram illustrating an example of an appearance when an authentication target person performs face authentication processing by using the information processing apparatus.

FIG. 3 is a diagram illustrating an example of a functional configuration of the information processing apparatus.

FIG. 4 is a flowchart illustrating an example of a processing procedure in a method of controlling the information processing apparatus.

FIG. 5 is a diagram illustrating processing in step S101 of FIG. 4.

FIG. 6 is a diagram illustrating processing in step S102 of FIG. 4.

FIG. 7 is a diagram illustrating processing in step S108 of FIG. 4.

FIG. 8 is a diagram illustrating processing in step S109 of FIG. 4.

FIG. 9 is a flowchart illustrating an example of a processing procedure in a method of determining whether to display a specific mark on a display in conjunction with a position and orientation of the information processing apparatus in step S103 of FIG. 4.

FIG. 10 is a diagram illustrating processing in step S201 of FIG. 9.

FIG. 11 is a diagram illustrating processing in step S202 of FIG. 9.

FIG. 12 is a diagram illustrating the processing in step S202 of FIG. 9.

FIG. 13 is a diagram illustrating processing in step S204 of FIG. 9.

FIG. 14 is a table illustrating the processing in step S107 of FIG. 9.

FIG. 15 is a diagram illustrating an example of an appearance of an information processing apparatus.

FIG. 16 is a diagram illustrating an example of an appearance when an authentication target person performs face authentication processing by using the information processing apparatus.

FIG. 17 is a diagram illustrating processing in step S102 of FIG. 4.

### DESCRIPTION OF THE EMBODIMENTS

Some exemplary embodiments of the present disclosure are described below with reference to the drawings. Configurations described in the following exemplary embodiments are merely illustrative, and the present disclosure is not limited to the configurations illustrated in the drawings.

A first exemplary embodiment is described.

In the first exemplary embodiment, an information processing apparatus that includes a face authentication function of an authentication target person, an operation authentication function of performing authentication on operation by the authentication target person by using a specific mark, and an authentication determination function of performing authentication determination on the authentication target person based on results of face authentication and operation authentication, is described. The face authentication according to the present exemplary embodiment is not particularly restricted in place and can be performed at any place. Therefore, the face authentication according to the present exemplary embodiment is effective, for example, in a case where identity verification by electronic Know Your Customer (eKYC) is performed at home.

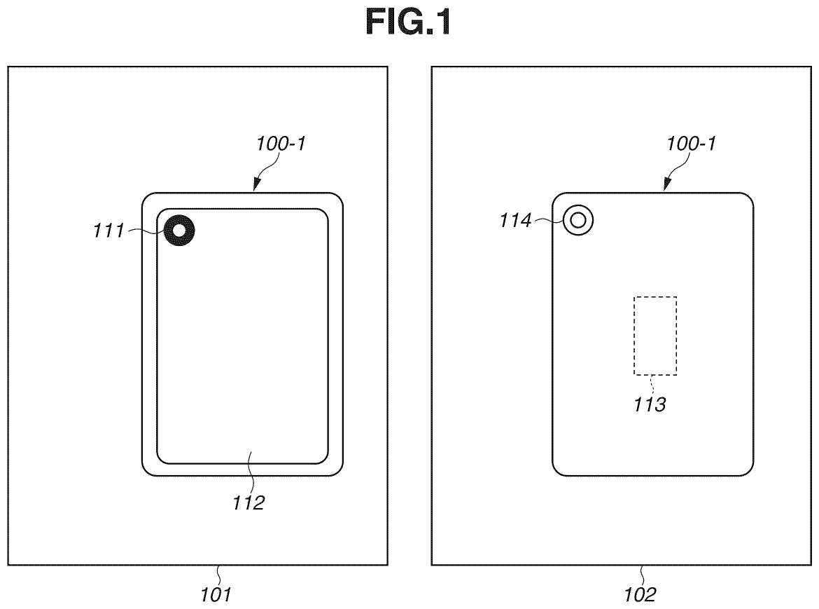

FIG. 1 is a diagram illustrating an example of an appearance of an information processing apparatus 100-1 according to the first exemplary embodiment.

As the information processing apparatus 100-1, a mobile information terminal apparatus that can be operated by the authentication target person while being held (carried) by the authentication target person is suitably applied.

An appearance 101 illustrated in FIG. 1 indicates an appearance of an inner surface of the information processing apparatus 100-1. An inner surface-side camera 111 that is a first imaging unit and a display 112 that is a display unit are provided on an inner surface side of the information processing apparatus 100-1. The inner surface-side camera 111 is a camera that images a view in front of the inner surface of the information processing apparatus 100-1 and can image the authentication target person (in particular, the face of the authentication target person in the present exemplary embodiment) who visually checks and the like the display 112 and operates the information processing apparatus 100-1. The display 112 displays various kinds of images and various kinds of information.

An appearance 102 illustrated in FIG. 1 indicates an appearance of an outer surface (surface on a side opposite to the inner surface of the information processing apparatus 100-1 indicated by the appearance 101 in FIG. 1) of the information processing apparatus 100-1. An outer surface-side camera 114 that is a second imaging unit is provided on an outer surface side of the information processing apparatus 100-1. The outer surface-side camera 114 is a camera that images a view in front of the outer surface of the information processing apparatus 100-1. A sensor 113 for measuring a position and orientation of the information processing apparatus 100-1 is provided inside the information processing apparatus 100-1. The sensor 113 is a sensor that can estimate relative changes from an initial position and orientation, such as an inertial measurement unit.

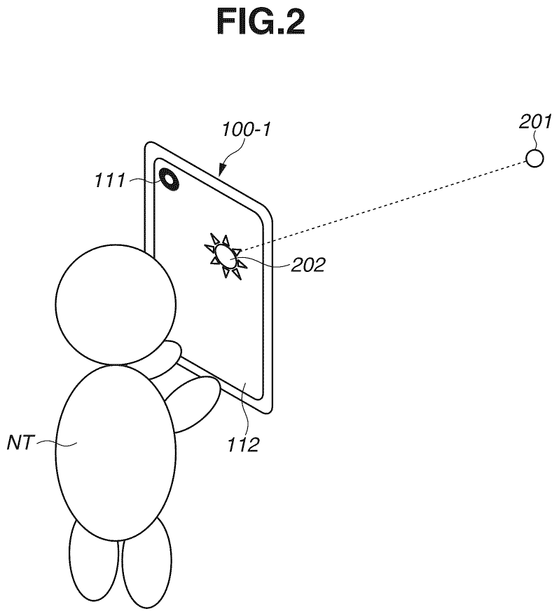

FIG. 2 is a diagram illustrating an example of an appearance when an authentication target person NT performs face authentication processing by using the information processing apparatus 100-1 according to the first exemplary embodiment. In FIG. 2, components similar to the components illustrated in FIG. 1 are denoted by the same reference numerals, and detailed descriptions of the components are omitted.

The authentication target person NT is positioned on the front side of the inner surface of the information processing apparatus 100-1 on which the inner surface-side camera 111 and the display 112 are provided. A mark 201 (a virtual mark in this example) is disposed in a three-dimensional space, and a mark 202 based on the mark 201 is displayed on the display 112 based on the position and orientation of the information processing apparatus 100-1 in the three-dimensional space. The authentication target person NT performs the face authentication processing and operation authentication processing by moving the information processing apparatus 100-1 such that the mark 202 displayed on the display 112 is continuously displayed on the display 112 in conjunction with the position and orientation of the information processing apparatus 100-1 in the three-dimensional space. In this way, the information processing apparatus 100-1 performs authentication of the authentication target person NT.

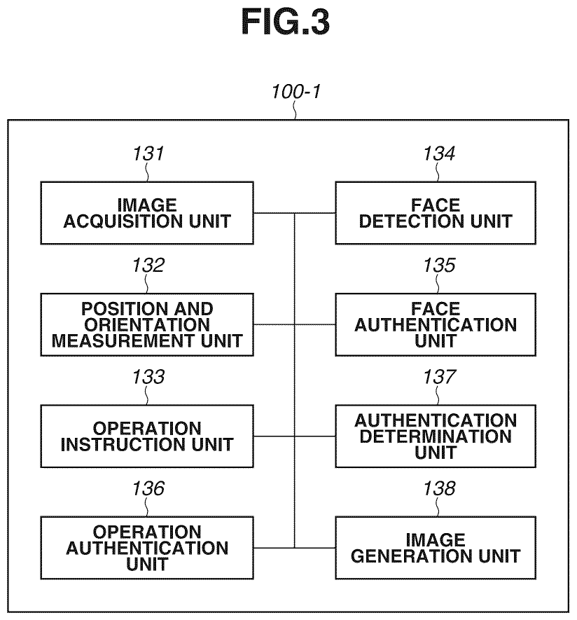

FIG. 3 is a diagram illustrating an example of a functional configuration of the information processing apparatus 100-1 according to the first exemplary embodiment. The information processing apparatus 100-1 includes functional components of an image acquisition unit 131, a position and orientation measurement unit 132, an operation instruction unit 133, a face detection unit 134, a face authentication unit 135, an operation authentication unit 136, an authentication determination unit 137, and an image generation unit 138. The functional components illustrated in FIG. 3 are all communicably connected and can mutually transmit and receive images and information.

The image acquisition unit 131 is an acquisition unit that acquires a face image of the authentication target person NT as a camera image captured using the inner surface-side camera 111.

The position and orientation measurement unit 132 is a measurement unit that measures the position and orientation of the information processing apparatus 100-1 by using the sensor 113.

The operation instruction unit 133 is an operation instruction unit that issues an instruction to the authentication target person NT to perform an operation while holding the information processing apparatus 100-1 during the face authentication processing.

The face detection unit 134 is a face detection unit that detects the face of the authentication target person NT from the face image of the authentication target person NT acquired by the image acquisition unit 131.

The face authentication unit 135 is a face authentication unit that performs face authentication of the authentication target person NT by determining whether faces of persons previously authenticated and registered include the face that is identical to (that matches) the face of the authentication target person NT detected by the face detection unit 134. In a case where the faces of persons previously authenticated and registered include the face that is identical to (that matches) the face of the authentication target person NT detected by the face detection unit 134, the face authentication unit 135 determines that the face authentication of the authentication target person NT has succeeded. In contrast, in a case where the faces of persons previously authenticated and registered do not include the face that is identical to (that matches) the face of the authentication target person NT detected by the face detection unit 134, the face authentication unit 135 determines that the face authentication of the authentication target person NT has failed.

The operation authentication unit 136 is an operation authentication unit that performs operation authentication of the authentication target person NT based on the operation according to the instruction issued by the operation instruction unit 133 and an actual operation of the information processing apparatus 100-1. At this time, the operation authentication unit 136 detects the actual operation of the information processing apparatus 100-1 based on the position and orientation of the information processing apparatus 100-1 measured by the position and orientation measurement unit 132. More specifically, in a case where the operation according to the instruction issued by the operation instruction unit 133 matches the actual operation of the information processing apparatus 100-1, the operation authentication unit 136 determines that the operation authentication of the authentication target person NT has succeeded. In contrast, in a case where the operation according to the instruction issued by the operation instruction unit 133 does not match the actual operation of the information processing apparatus 100-1, the operation authentication unit 136 determines that the operation authentication of the authentication target person NT has failed.

In a case where the face authentication by the face authentication unit 135 has succeeded and the operation authentication by the operation authentication unit 136 has succeeded, the authentication determination unit 137 determines that authentication of the authentication target person NT has succeeded. In contrast, in a case where at least one of the face authentication by the face authentication unit 135 and the operation authentication by the operation authentication unit 136 has failed, the authentication determination unit 137 determines that the authentication of the authentication target person NT has failed. In addition, in a case where the face authentication by the face authentication unit 135 has succeeded but the operation authentication by the operation authentication unit 136 has failed, the authentication determination unit 137 determines that the authentication of the authentication target person NT has failed and determines that a spoofing action of spoofing the authentication target person NT has been performed.

The image generation unit 138 is an image generation unit that generates an image including various kinds of images and various kinds of information obtained by the functional components (131 to 137). The image generated by the image generation unit 138 can be displayed on the display 112. The image displayed on the display 112 includes information indicating a determination result of the authentication determination unit 137.

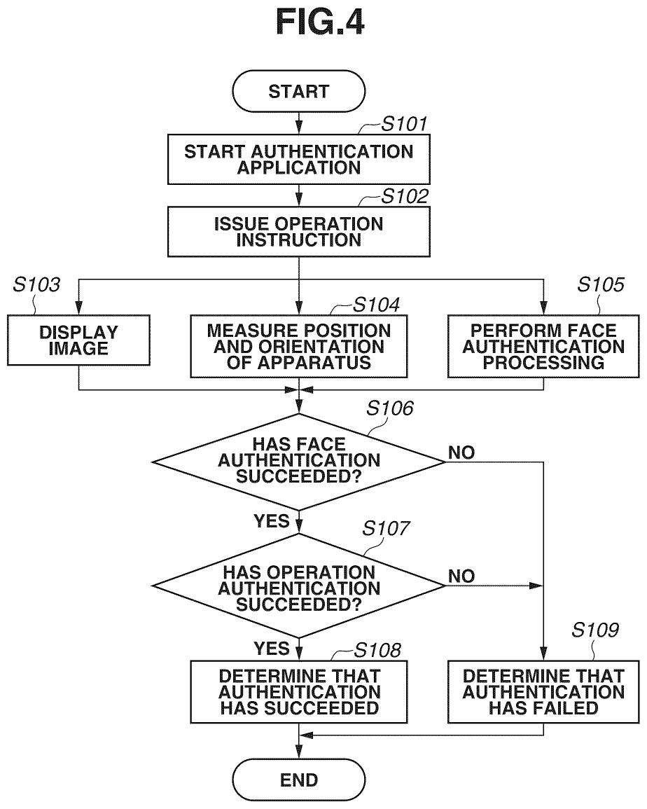

FIG. 4 is a flowchart illustrating an example of a processing procedure in a method of controlling the information processing apparatus 100-1 according to the first exemplary embodiment. Processing for authenticating the authentication target person NT is described below with reference to FIG. 4. In the following description, an example in which an operation time (time limit) of the authentication processing is set to 10 seconds is described as a specific example; however, the operation time (time limit) of the authentication processing may be appropriately changed and set depending on an environment, a use case, and the like.

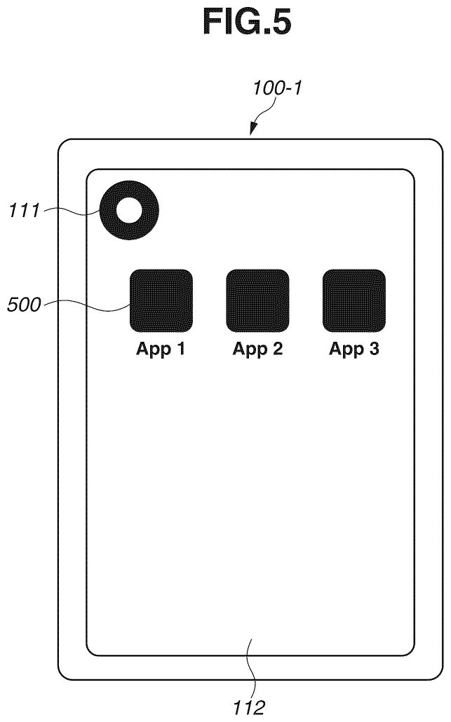

In step S101 of FIG. 4, the information processing apparatus 100-1 starts an authentication application in order to perform authentication of the authentication target person NT. FIG. 5 is a diagram illustrating the processing in step S101 of FIG. 4 according to the first exemplary embodiment. In FIG. 5, components similar to the components illustrated in FIG. 1 and FIG. 2 are denoted by the same reference numerals, and detailed descriptions of the components are omitted. In FIG. 5, a button 500 is a button for starting up the authentication application. When the authentication target person NT presses the button 500, the information processing apparatus 100-1 detects a press thereon and starts the authentication application.

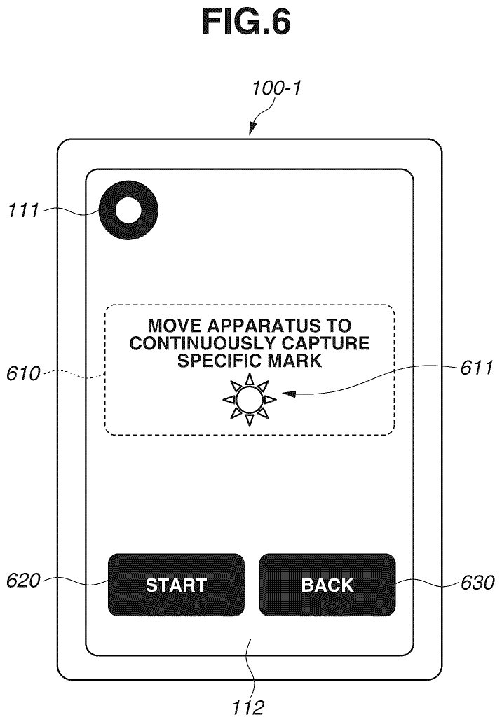

Subsequently, in step S102 of FIG. 4, during the face authentication processing, the operation instruction unit 133 issues an instruction to the authentication target person NT to perform an operation while holding the information processing apparatus 100-1. More specifically, in the present exemplary embodiment, the operation instruction unit 133 issues the instruction to the authentication target person NT to perform the operation while holding the information processing apparatus 100-1 by displaying an operation instruction on the display 112. FIG. 6 is a diagram illustrating the processing in step S102 of FIG. 4 according to the first exemplary embodiment. In FIG. 6, components similar to the components illustrated in FIG. 1, FIG. 2, and FIG. 5 are denoted by the same reference numerals, and detailed descriptions of the components are omitted.

A screen displayed on the display 112 illustrated in FIG. 6 is an example of an image displayed after the button 500 illustrated in FIG. 5 is pressed. An operation instruction content display area 610, a “Start” button 620, and a “Back” button 630 are displayed on the display 112 illustrated in FIG. 6. An operation instruction to “move apparatus to continuously capture specific mark (611)” is displayed in the operation instruction content display area 610 illustrated in FIG. 6. The authentication target person NT can start the authentication processing by pressing the “Start” button 620. In addition, the authentication target person NT can end the authentication application by pressing the “Back” button 630. When the authentication target person NT presses the “Start” button 620 to start the face authentication processing, processing in steps S103, S104, and S105 illustrated in FIG. 4 described below is performed. In the example illustrated in FIG. 4, the processing in steps S103, S104, and S105 described below is simultaneously started, processed in parallel, and ends after the processing is continuously performed for 10 seconds, which is the operation time (time limit) of the authentication processing. The authentication target person NT can make the authentication processing a success by continuously moving the information processing apparatus 100-1 to continuously capture the specific mark 611 displayed in the operation instruction content display area 610 illustrated in FIG. 6 for 10 seconds, which is the operation time (time limit) of the authentication processing.

In step S103 after completion of step S102 of FIG. 4, the display 112 displays the specific mark 611 corresponding to the mark 202 based on the position and orientation of the information processing apparatus 100-1 measured by the position and orientation measurement unit 132 and the position of the mark 201. Depending on the position and orientation of the information processing apparatus 100-1 and the position of the mark 201, however, the specific mark 611 corresponding to the mark 202 may not be displayed on the display 112.

In step S104 after completion of step S102 of FIG. 4, to detect an operation that the authentication target person NT performs while holding the information processing apparatus 100-1, the position and orientation measurement unit 132 measures the position and orientation of the information processing apparatus 100-1. In the present exemplary embodiment, the position and orientation measurement unit 132 measures the position and orientation thereof while the authentication target person NT operates the information processing apparatus 100-1 at a rate of 30 times per second by using the sensor 113, and stores measurement results. In this case, since the operation time (time limit) of the authentication processing is 10 seconds in the present exemplary embodiment, 300 pieces of information indicating the position and orientation of the information processing apparatus 100-1 are stored in total.

In step S105 after completion of step S102 of FIG. 4, the face authentication unit 135 performs the face authentication processing using the face image of the authentication target person NT acquired using the inner surface-side camera 111 while the authentication target person NT performs the operation while holding the information processing apparatus 100-1. In the present exemplary embodiment, the face authentication unit 135 performs the face authentication processing at a rate of two times per second. In this case, since the operation time (time limit) of the authentication processing is 10 seconds in the present exemplary embodiment, the face authentication processing is performed 20 times in total.

After 10 seconds that is the operation time (time limit) of the authentication processing is elapsed, the processing proceeds to step S106 of FIG. 4. In step S106 of FIG. 4, the face authentication unit 135 determines whether the face authentication of the authentication target person NT has succeeded based on the result of the face authentication processing in step S105 of FIG. 4. In the present exemplary embodiment, in a case where a result indicating that the face of the authentication target person NT is identical to (matches) a face of a person previously authenticated and registered is obtained in 90% or more of the face authentication processing performed in step S105 of FIG. 4, namely, 18 or more times, the face authentication unit 135 determines that the face authentication has succeeded. Otherwise, the face authentication unit 135 determines that the face authentication has failed.

In step S106 of FIG. 4, in a case where the face authentication unit 135 determines that the face authentication of the authentication target person NT has succeeded (YES in step S106), the processing proceeds to step S107. In step S107 of FIG. 4, the operation authentication unit 136 determines whether the operation authentication of the authentication target person NT has succeeded based on the operation according to the instruction issued by the operation instruction unit 133 and the actual operation of the information processing apparatus 100-1 based on the position and orientation measured in step S104. More specifically, the operation authentication unit 136 analyzes the information indicating the position and orientation of the information processing apparatus 100-1 stored in step S104 and detects operation contents performed on the information processing apparatus 100-1 by the authentication target person NT during the authentication processing. Then, the operation authentication unit 136 compares the detected operation contents with the operation contents according to the instruction issued in step S102 and determines whether the operation authentication of the authentication target person NT has succeeded based on whether the operation contents match each other. More specifically, in a case where the operation according to the instruction issued by the operation instruction unit 133 and the actual operation of the information processing apparatus 100-1 match each other, the operation authentication unit 136 determines that the operation authentication of the authentication target person NT has succeeded. In contrast, in a case where the operation according to the instruction issued by the operation instruction unit 133 and the actual operation of the information processing apparatus 100-1 do not match each other, the operation authentication unit 136 determines that the operation authentication of the authentication target person NT has failed.

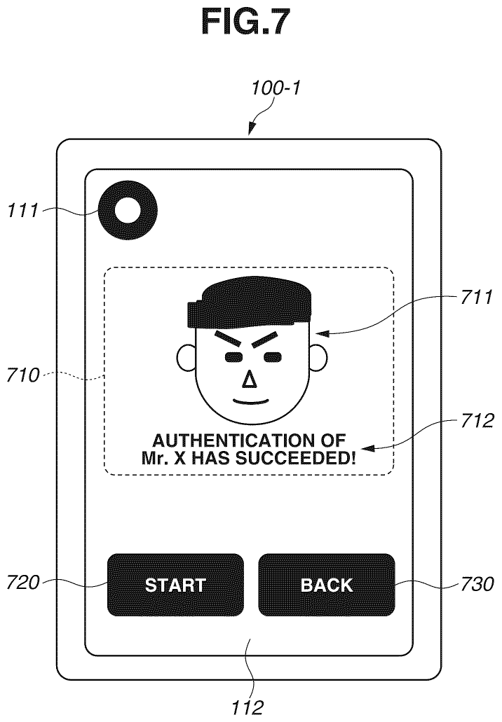

In step S107 of FIG. 4, in a case where the operation authentication unit 136 determines that the operation authentication of the authentication target person NT has succeeded (YES in step S107), the processing proceeds to step S108 of FIG. 4. In step S108 of FIG. 4, the authentication determination unit 137 determines that the authentication of the authentication target person NT has succeeded. In other words, since it is determined in step S106 that the face authentication has succeeded and it is determined in step S107 that the operation authentication has succeeded, the authentication determination unit 137 determines that the authentication of the authentication target person NT has succeeded. In the processing in step S108 of FIG. 4, the authentication determination unit 137 performs processing for displaying that the authentication of the authentication target person NT has succeeded on the display 112. FIG. 7 is a diagram illustrating the processing in step S108 of FIG. 4 according to the first exemplary embodiment.

In FIG. 7, components similar to the components illustrated in FIG. 1, FIG. 2, FIG. 5, and FIG. 6 are denoted by the same reference numerals, and detailed descriptions of the components are omitted. In FIG. 7, an authentication success display area 710, a “Start” button 720, and a “Back” button 730 are displayed on the display 112. A registered image 711 corresponding to the authentication target person NT and information 712 indicating that the authentication has succeeded are displayed in the authentication success display area 710 illustrated in FIG. 7. When the authentication target person NT presses the “Start” button 720 in this state, the processing returns to step S102 of FIG. 4. When the authentication target person NT presses the “Back” button 730, the processing in the flowchart illustrated in FIG. 4 ends.

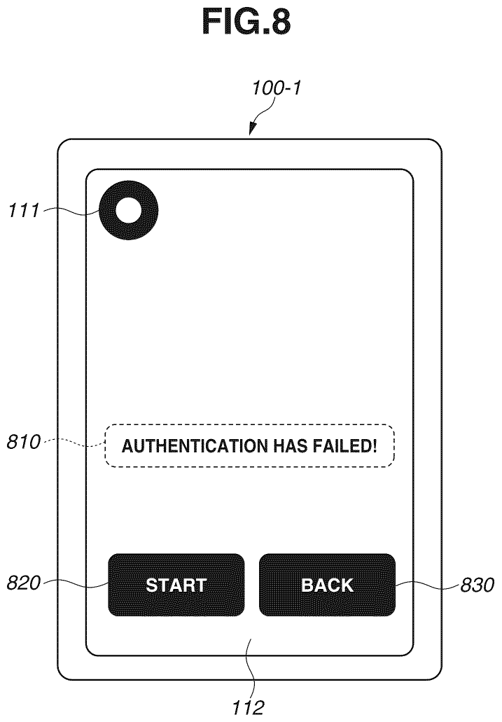

In step S106 of FIG. 4, in a case where the face authentication unit 135 determines that the face authentication of the authentication target person NT has failed (NO in step S106), the processing proceeds to step S109 of FIG. 4. Likewise, in step S107 of FIG. 4, in a case where the operation authentication unit 136 determines that the operation authentication of the authentication target person NT has failed (NO in step S107), the processing proceeds to step S109 of FIG. 4. In step S109 of FIG. 4, the authentication determination unit 137 determines that the authentication of the authentication target person NT has failed. In other words, since it is determined in step S106 that the face authentication has failed or it is determined in step S107 that the operation authentication has failed, the authentication determination unit 137 determines that the authentication of the authentication target person NT has failed. Note that in a case where it is determined in step S106 that the face authentication has succeeded but it is determined in step S107 that the operation authentication has failed, the authentication determination unit 137 determines that the authentication of the authentication target person NT has failed and determines that a spoofing action of spoofing the authentication target person NT has been performed. In the processing in step S109 of FIG. 4, the authentication determination unit 137 performs processing for displaying that the authentication of the authentication target person NT has failed on the display 112. FIG. 8 is a diagram illustrating the processing in step S109 of FIG. 4 according to the first exemplary embodiment. In FIG. 8, components similar to the components illustrated in FIG. 1, FIG. 2, and FIG. 5 to FIG. 7 are denoted by the same reference numerals, and detailed descriptions of the components are omitted. In FIG. 8, an authentication failure display area 810, a “Start” button 820, and a “Back” button 830 are displayed on the display 112. Information indicating that the authentication has failed is displayed in the authentication failure display area 810 illustrated in FIG. 8. When the authentication target person NT presses the “Start” button 820 in this state, the processing returns to step S102 of FIG. 4. When the authentication target person NT presses the “Back” button 830, the processing in the flowchart illustrated in FIG. 4 ends.

In the above description of the flowchart illustrated in FIG. 4, the processing for measuring the position and orientation of the information processing apparatus 100-1 in step S104 and the face authentication processing in step S105 are simultaneously started and are processed in parallel. In the present exemplary embodiment, however, the processing is not limited thereto. For example, after the processing for measuring the position and orientation of the information processing apparatus 100-1 in step S104 is performed, the face authentication processing in step S105 may be performed.

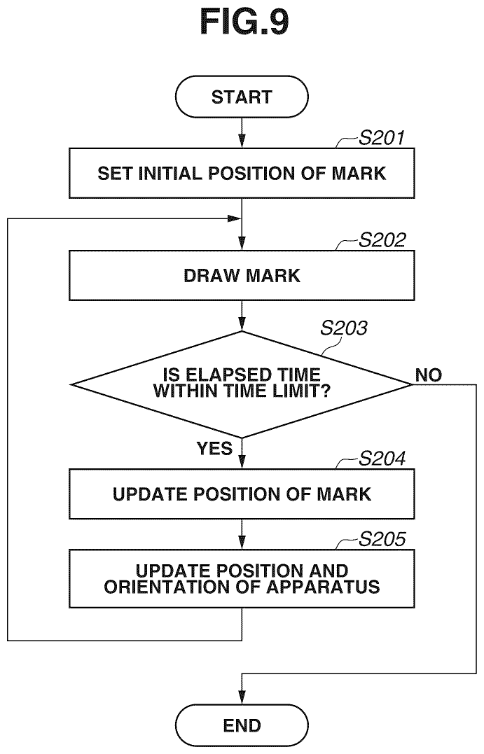

Next, a method of determining whether to display the specific mark 611 on the display 112 in conjunction with the position and orientation of the information processing apparatus 100-1 in a three-dimensional space in step S103 of FIG. 4 is described. FIG. 9 is a flowchart illustrating an example of a processing procedure in the method of determining whether to display the specific mark 611 on the display 112 in conjunction with the position and orientation of the information processing apparatus 100-1 in step S103 of FIG. 4 according to the first exemplary embodiment.

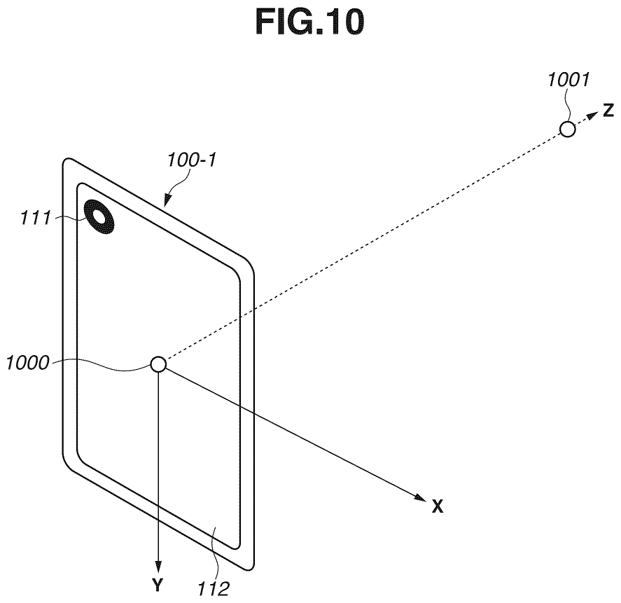

First, in step S201 of FIG. 9, the information processing apparatus 100-1 sets an initial position of a mark disposed in the three-dimensional space. In this example, at a start time of the authentication processing, the information processing apparatus 100-1 sets the position of the mark such that the mark is positioned 2 m ahead of the information processing apparatus 100-1 in the three-dimensional space based on the information on the position and orientation acquired using the sensor 113. FIG. 10 is a diagram illustrating processing in step S201 of FIG. 9 according to the first exemplary embodiment. In FIG. 10, components similar to the components illustrated in FIG. 1, FIG. 2, and FIG. 5 to FIG. 8 are denoted by the same reference numerals, and detailed descriptions of the components are omitted. In FIG. 10, a point 1000 indicates the position of the information processing apparatus 100-1 at the start time of the authentication processing. A point 1001 indicates a point positioned 2 m ahead of the point 1000 in a depth direction. Therefore, in step S201 of FIG. 9, the initial position of the mark is set to the position of the point 1001 in FIG. 10.

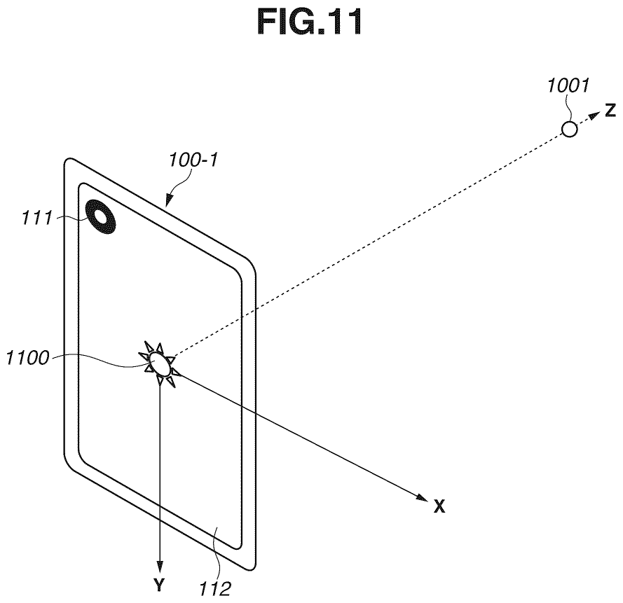

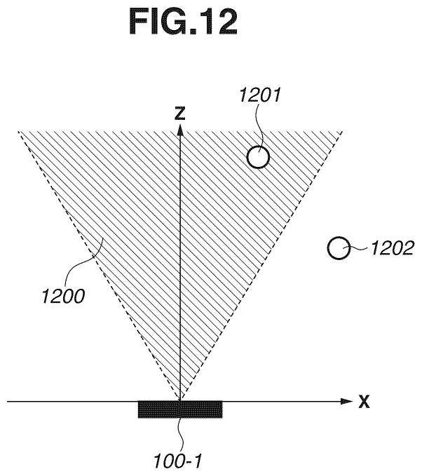

Subsequently, in step S202 of FIG. 9, the information processing apparatus 100-1 draws the mark on the display 112 based on the position and orientation of the information processing apparatus 100-1 measured by the position and orientation measurement unit 132 and the position of the mark. FIG. 11 is a diagram illustrating processing in step S202 of FIG. 9 according to the first exemplary embodiment. In FIG. 11, components similar to the components illustrated in FIG. 1, FIG. 2, FIG. 5 to FIG. 8, and FIG. 10 are denoted by the same reference numerals, and detailed descriptions of the components are omitted. For example, in a case where the processing transitions from step S201 to step S202 of FIG. 9, as illustrated in FIG. 11, the information processing apparatus 100-1 draws a mark 1100 at the position of the point 1000 illustrated in FIG. 10. In a case where the processing transitions from step S205 to step S202 of FIG. 9, the information processing apparatus 100-1 determines a drawing position of the mark by using the position of the mark updated in step S204 and the position and orientation updated in step S205, and draws the mark 1100. However, for example, in a case where the position of the point 1001 is out of a visual field of the outer surface-side camera 114 as viewed from the information processing apparatus 100-1, the mark 1100 is not drawn. FIG. 12 is a diagram illustrating the processing in step S202 of FIG. 9 according to the first exemplary embodiment. More specifically, FIG. 12 is a diagram illustrating a relationship between the visual field of the outer surface-side camera 114 as viewed from the information processing apparatus 100-1 and the position of the mark set in the three-dimensional space.

FIG. 12 illustrates an area 1200 within the visual field of the outer surface-side camera 114 as viewed from the information processing apparatus 100-1, a point 1201 within the area 1200, and a point 1202 out of the area 1200. In a case where the position of the mark set in the three-dimensional space is out of the visual field of the outer surface-side camera 114 as viewed from the information processing apparatus 100-1 as in the case of the point 1202 illustrated in FIG. 12, the mark 1100 is not drawn.

Subsequently, in step S203 of FIG. 9, the information processing apparatus 100-1 determines whether an elapsed time from the start time of the authentication processing is within the time limit. In the present exemplary embodiment, the time limit that is the operation time of the authentication processing is 10 seconds. Therefore, in a case where the elapsed time from the start time of the authentication processing is 10 seconds or less (YES in step S203), the processing proceeds to step S204.

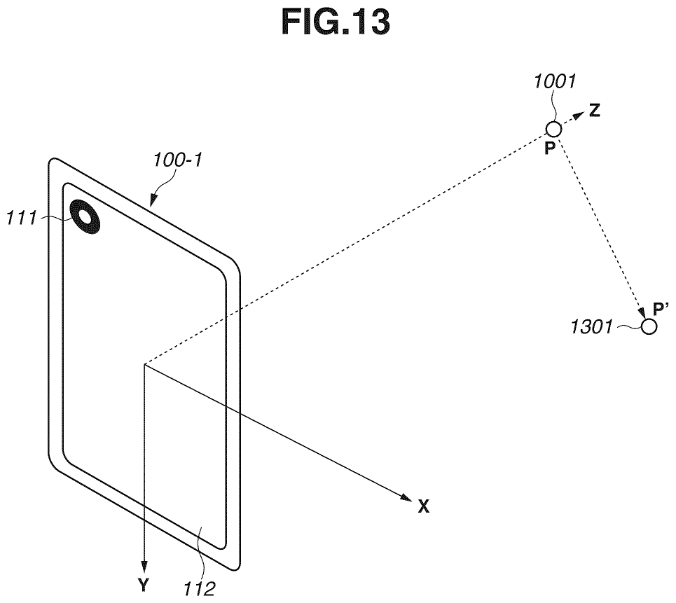

Subsequently, in step S204 of FIG. 9, the information processing apparatus 100-1 (e.g., the operation instruction unit 133) updates the position of the mark set in the three-dimensional space. In the present exemplary embodiment, the position of the mark is updated using random numbers r_x, r_y, and r_z according to uniform distribution from −1 m to +1 m. However, the position of the mark may be updated by another method. For example, a straight line or a curved line may be set in the three-dimensional space, and the position of the mark may be updated so as to move on the line at a constant speed. When positional coordinates of the mark before the update are P(x, y, z) and the positional coordinates of the mark after the update are P′ (x′, y′, z′), x′=x+r_x, y′=y+r_y, and z′=z+r_z are established. FIG. 13 is a diagram illustrating processing in step S204 of FIG. 9 according to the first exemplary embodiment. More specifically, FIG. 13 is a diagram illustrating an example in a case where the position of the mark is updated from a position (initial position) P before the update to a position P′. In the example illustrated in FIG. 13, the initial position P of the mark is positioned at the point 1001, and the position P′ of the mark after the update is positioned at a point 1301. In the example illustrated in FIG. 13, the processing for updating the position of the mark from the initial position is described. Similarly, in a second or subsequent update, other random numbers are generated to generate a new position of the mark, and the position of the mark is updated.

Subsequently, in step S205 of FIG. 9, the information processing apparatus 100-1 acquires the latest position and orientation of the information processing apparatus 100-1 from the sensor 113 and updates the position and orientation of the information processing apparatus 100-1. Then, the processing returns to step S202.

In step S203 of FIG. 9, in a case where the elapsed time from the start time of the authentication processing is not within the time limit (NO in step S203), more specifically, in a case where the elapsed time exceeds 10 seconds that is the time limit, the processing in the flowchart illustrated in FIG. 9 ends.

Next, a specific example of the operation authentication processing in step S107 of FIG. 4 is described. In step S107 of FIG. 4, the operation authentication unit 136 performs the operation authentication processing of the authentication target person NT based on the operation according to the instruction issued by the operation instruction unit 133 and the actual operation of the information processing apparatus 100-1 based on the position and orientation measured in step S104. In the present exemplary embodiment, the operation authentication unit 136 determines whether the position and orientation of the information processing apparatus 100-1 is appropriate at each time point during the operation time of the authentication processing. In a case where the position and orientation thereof is appropriate at 90% or more of time points, the operation authentication unit 136 determines that the actual operation matches the operation according to the instruction issued in step S102.

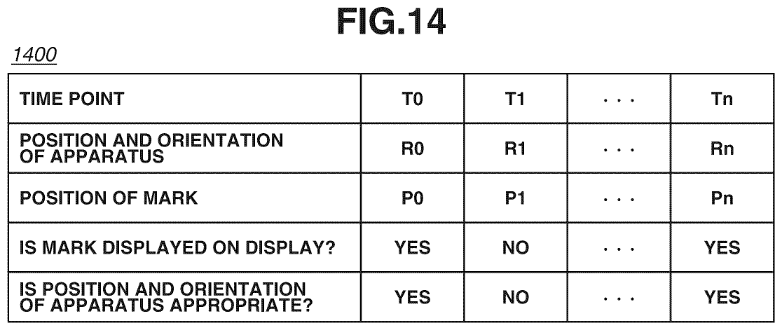

In the present exemplary embodiment, in step S102 of FIG. 4, the operation instruction to “move apparatus to continuously capture specific mark (611)” is issued as displayed in the operation instruction content display area 610 illustrated in FIG. 6. Thus, in a case where the specific mark (611) is displayed on the display 112 at each time point during the operation time of the authentication processing, the operation authentication unit 136 determines that the position and orientation of the information processing apparatus 100-1 is appropriate. It is possible to determine whether the mark is displayed on the display 112 from the position of the mark in the three-dimensional space and the position and orientation of the information processing apparatus 100-1 in a manner similar to the processing in step S202 of FIG. 9. FIG. 14 is a table illustrating the processing in step S107 of FIG. 4 according to the first exemplary embodiment. FIG. 14 illustrates each time point (T0 to Tn), the position and orientation (R0 to Rn) of the information processing apparatus, whether the mark is displayed on the display (YES/NO), and whether the position and orientation of the information processing apparatus is appropriate (YES/NO) during the authentication processing. As illustrated in FIG. 14, the operation authentication unit 136 analyzes whether the mark is displayed on the display 112 at each time point (T0 to Tn) during the authentication processing. In a case where the mark is displayed on the display 112, the operation authentication unit 136 determines that the position and orientation of the information processing apparatus 100-1 is appropriate. Then, the operation authentication unit 136 calculates a percentage of the position and orientation of the information processing apparatus 100-1 determined to be appropriate. In a case where the calculated percentage is 90% or more, the operation authentication unit 136 determines that the actual operation matches the operation according to the instruction issued in step S102.

In the information processing apparatus 100-1 according to the first exemplary embodiment described above, the face authentication unit 135 performs the face authentication of the authentication target person NT, and the operation authentication unit 136 performs the operation authentication of the authentication target person NT. In the case where the face authentication by the face authentication unit 135 has succeeded and the operation authentication by the operation authentication unit 136 has succeeded, the authentication determination unit 137 determines that the authentication of the authentication target person NT has succeeded.

In contrast, in the case where the face authentication by the face authentication unit 135 has failed or the operation authentication by the operation authentication unit 136 has failed, the authentication determination unit 137 determines that the authentication of the authentication target person NT has failed.

According to the configuration, it is possible to perform high-accuracy authentication of the authentication target person while simplifying preparation of the authentication.

In addition, in the case where the face authentication by the face authentication unit 135 has succeeded but the operation authentication by the operation authentication unit 136 has failed, the authentication determination unit 137 determines that the authentication of the authentication target person NT has failed and determines that a spoofing action of spoofing the authentication target person NT has been performed.

According to the configuration, it is possible to reduce a risk of spoofing.

A second exemplary embodiment is described. In the following description of the second exemplary embodiment, a description of a matter common to the above-described first exemplary embodiment is omitted, and a matter different from the above-described first exemplary embodiment is described.

In the above-described first exemplary embodiment, the operation instruction (in step S102 of FIG. 4) during the face authentication processing is to move the apparatus such that the specific mark based on a virtual mark is continuously displayed on the display. In the above-described first exemplary embodiment, the position of the mark is set to a position near the initial position of the apparatus. Thus, it is possible to make the face authentication a success at any place, and a place where the authentication target person NT has performed the face authentication cannot be specified. For example, in a case where the face authentication is used to check attendance at a class in school, there is a case where the authentication can succeed even though the authentication target person NT is not actually present in a classroom but is present in another building or the like. Thus, in the second exemplary embodiment, a configuration of issuing an operation instruction requiring the authentication target person NT to be present in a specific place is described. The second exemplary embodiment is particularly effective in a case where a place of the authentication is important such as the above-described case of checking attendance at a class in school.

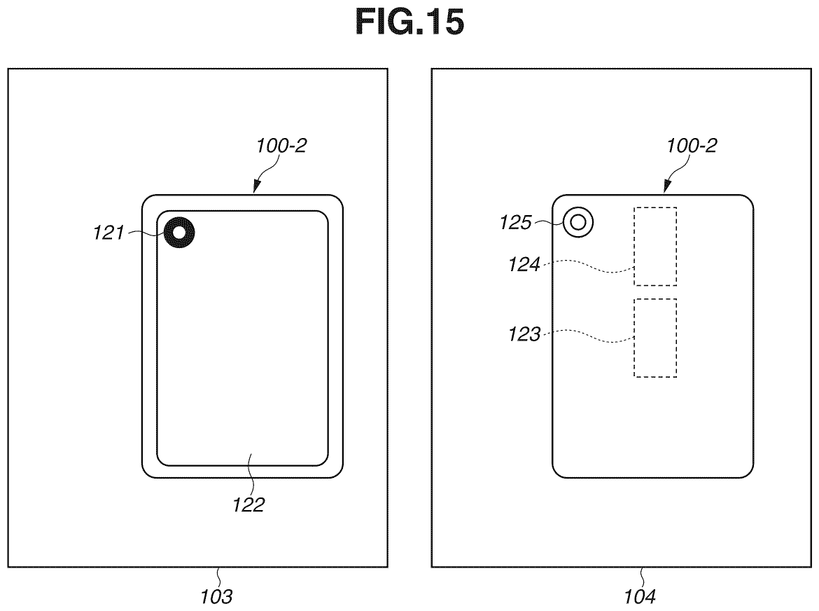

FIG. 15 is a diagram illustrating an example of an appearance of an information processing apparatus 100-2 according to the second exemplary embodiment. As the information processing apparatus 100-2, a mobile information terminal apparatus that can be operated by the authentication target person while being held (carried) by the authentication target person is suitably applied.

An appearance 103 illustrated in FIG. 15 indicates an appearance of an inner surface of the information processing apparatus 100-2. An inner surface-side camera 121 that is a first imaging unit and a display 122 that is a display unit are provided on an inner surface side of the information processing apparatus 100-2. The inner surface-side camera 121 is a camera that images a view in front of the inner surface of the information processing apparatus 100-2 and can image the authentication target person (in particular, the face of the authentication target person in the present exemplary embodiment) who visually checks and the like the display 112 and operates the information processing apparatus 100-2. The display 122 displays various kinds of images and various kinds of information.

An appearance 104 illustrated in FIG. 15 indicates an appearance of an outer surface (surface on a side opposite to the inner surface of the information processing apparatus 100-2 indicated by the appearance 103 in FIG. 15) of the information processing apparatus 100-2. An outer surface-side camera 125 that is a second imaging unit is provided on an outer surface side of the information processing apparatus 100-2.

The outer surface-side camera 125 is a camera that images a view in front of the outer surface of the information processing apparatus 100-2.

A sensor 123 for measuring an absolute orientation of the information processing apparatus 100-2 and a sensor 124 for measuring an absolute position thereof are provided inside the information processing apparatus 100-2. The sensor 123 is a sensor that can estimate the absolute orientation, for example, an inertial measurement unit including a magnetic sensor. For example, in a case where the information processing apparatus 100-2 is assumed to be used outdoors, the sensor 124 may be implemented by a global navigation satellite system (GNSS) or the like. For example, in a case where the information processing apparatus 100-2 is assumed to be used indoors, the sensor 124 may be a sensor that estimates a position based on radio wave intensity of Wi-Fi, a sensor using ultra-wideband (UWB) positioning, or the like.

A functional configuration of the information processing apparatus 100-2 according to the second exemplary embodiment is similar to the functional configuration of the information processing apparatus 100-1 according to the first exemplary embodiment illustrated in FIG. 3.

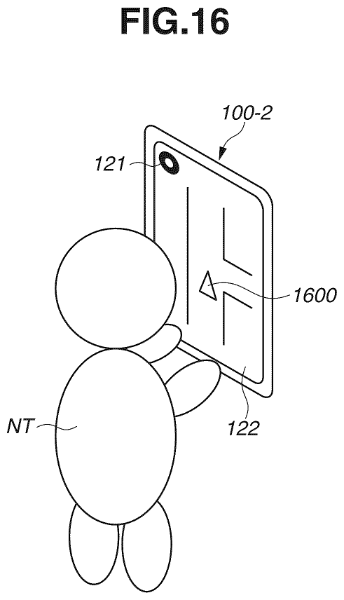

FIG. 16 is a diagram illustrating an example of an appearance when the authentication target person NT performs face authentication processing by using the information processing apparatus 100-2 according to the second exemplary embodiment. In FIG. 16, components similar to the components illustrated in FIG. 15 are denoted by the same reference numerals, and detailed descriptions of the components are omitted.

The authentication target person NT is positioned on the front side of the inner surface of the information processing apparatus 100-2 on which the inner surface-side camera 121 and the display 122 are provided. A current position 1600 of the information processing apparatus 100-2 is displayed on the display 122 illustrated in FIG. 16. The authentication target person NT performs the face authentication processing and the operation authentication processing by moving to a designated position while holding the information processing apparatus 100-2. As described above, the information processing apparatus 100-2 also performs the authentication of the authentication target person NT.

A method of controlling the information processing apparatus 100-2 according to the second exemplary embodiment is basically similar to the processing in the flowchart illustrating the example of the processing procedure in the method of controlling the information processing apparatus 100-1 according to the first exemplary embodiment illustrated in FIG. 4. In the following description, differences from the processing in the above-described first exemplary embodiment are described with reference to FIG. 4.

In step S101 of FIG. 4, the information processing apparatus 100-2 starts the authentication application in a manner similar to the above-described first exemplary embodiment.

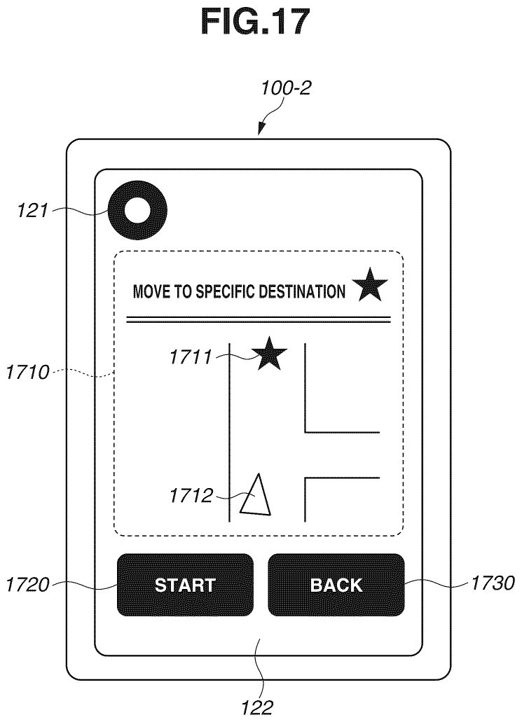

Subsequently, in step S102 of FIG. 4, during the face authentication processing, the operation instruction unit 133 issues an instruction to the authentication target person NT to perform an operation while holding the information processing apparatus 100-2 in a manner similar to the above-described first exemplary embodiment. More specifically, also in the present exemplary embodiment, the operation instruction unit 133 issues the instruction to the authentication target person NT to perform the operation while holding the information processing apparatus 100-2 by displaying an operation instruction on the display 122 in a manner similar to the above-described first exemplary embodiment. FIG. 17 is a diagram illustrating processing in step S102 of FIG. 4 according to the second exemplary embodiment. In FIG. 17, components similar to the components illustrated in FIG. 15 and FIG. 16 are denoted by the same reference numerals, and detailed descriptions of the components are omitted. A screen displayed on the display 122 illustrated in FIG. 17 is an example of an image displayed after the button 500 illustrated in FIG. 5 is pressed. An operation instruction content display area 1710, a “Start” button 1720, and a “Back” button 1730 are displayed on the display 122 illustrated in FIG. 17. An operation instruction to “move to specific destination (1711)” from a current position 1712 of the information processing apparatus 100-2 is displayed in the operation instruction content display area 1710 illustrated in FIG. 17. The destination 1711 is set in such a manner that, for example, a plurality of destination candidates is registered in advance in the information processing apparatus 100-2 and a nearest destination is selected based on the current position 1712 of the information processing apparatus 100-2. More specifically, for example, in a case of a system for checking attendance in a classroom, the destination is set in such a manner that the destination candidates are set to four corners of the classroom and the nearest corner thereof is selected as the destination 1711 based on the current position 1712 of the information processing apparatus 100-2.

Subsequently, in step S103 of FIG. 4, the display 122 displays the current position 1712 of the information processing apparatus 100-2 and the destination 1711 as illustrated in the operation instruction content display area 1710 in FIG. 17 based on the position and orientation of the information processing apparatus 100-2. At this time, the authentication target person NT moves to the destination 1711 while holding the information processing apparatus 100-2 and viewing the display 122.

In the second exemplary embodiment, in steps S104 to S106 of FIG. 4, processing similar to the processing in the above-described first exemplary embodiment is performed.

Subsequently, in step S107 of FIG. 4, the operation authentication unit 136 determines whether the operation authentication of the authentication target person NT has succeeded based on the operation according to the instruction issued by the operation instruction unit 133 and the actual operation of the information processing apparatus 100-2 based on the position and orientation measured in step S104. More specifically, in a case where a distance between the current position 1712 of the information processing apparatus 100-2 and the destination 1711 is greater than or equal to a threshold, the operation authentication unit 136 determines that the operation authentication of the authentication target person NT has failed. Otherwise, the operation authentication unit 136 determines that the operation authentication of the authentication target person NT has succeeded.

In step S107 of FIG. 4, in a case where the operation authentication unit 136 determines that the operation authentication of the authentication target person NT has succeeded (YES in step S107), the processing proceeds to step S108 of FIG. 4. In step S107 of FIG. 4, in a case where the operation authentication unit 136 determines that the operation authentication of the authentication target person NT has failed (NO in step S107), the processing proceeds to step S109 of FIG. 4. In the second exemplary embodiment, in steps S108 and S109 of FIG. 4, processing similar to the processing in the above-described first exemplary embodiment is performed.

According to the second exemplary embodiment, as in the above-described first exemplary embodiment, it is possible to perform high-accuracy authentication of the authentication target person while simplifying preparation of the authentication. Further, according to the second exemplary embodiment, it is possible to further reduce a risk of spoofing.

### MODIFICATIONS OF ABOVE-DESCRIBED EXEMPLARY EMBODIMENTS

Modifications of the above-described exemplary embodiments are described.

### First Modification

In the above-described first exemplary embodiment, in the case where the information processing apparatus 100-1 is moved such that the mark 611 illustrated in FIG. 6 is continuously displayed on the display 112, only the mark 611 is displayed on the display 112. Thus, if the mark 611 disappears from the display 112 once, it is difficult to find the mark again. Thus, in a first modification, for example, virtual reality (VR) may be used in addition to the mark, and a combined image obtained by combining a virtual environment and the mark may be displayed on the display 112. Further, in the first modification, for example, augmented reality (AR) may be used in addition to the mark, and a combined image obtained by combining a real environment captured by the outer surface-side camera 114 and the mark may be displayed on the display 112. As in the first modification, when the mark and the virtual environment or the real environment are simultaneously displayed on the display 112, even if the mark disappears from the display 112 once, it is easier to intuitively grasp a lost position of the mark. Therefore, the mark can be easily found again. In the first modification, in a case of using VR, for example, a result obtained by rendering a computer graphics (CG) model of a wide-area environment by using the current position and orientation of the information processing apparatus 100-1 is desirably displayed on the display 112. Further, in the case of using VR, only the virtual environment may be displayed on the display 112 by using a part of the virtual environment as a substitute for the mark. In the first modification, in a case of using AR, for example, a view in front of the outer surface of the information processing apparatus 100-1 is desirably imaged by the outer surface-side camera 114, the mark and the view are preferably combined to generate a combined image, and the combined image is preferably displayed on the display 112.

### Second Modification

In the above-described first exemplary embodiment, the place where the face authentication processing has been performed cannot be specified. To implement a method in which the authentication can succeed only at an assumed place, the position of the mark and the position and orientation of the information processing apparatus 100-1 with a certain coordinate system as a reference are desirably used without depending on the initial position and orientation of the information processing apparatus 100-1. A second modification can be realized by, for example, the following procedure.

As advance preparation, first, an environment is established where the position and orientation of the information processing apparatus 100-1 can be measured in real time with one coordinate system as a reference using a motion capture system using an environment-installation camera. Next, with the above-described coordinate system as the reference, an initial position of the mark and positions of the mark at respective time points after a start of the authentication processing are set in advance. Then, during the authentication processing, the processing in the above-described first exemplary embodiment is desirably performed using the position and orientation of the information processing apparatus 100-1 and the position of the mark with the above-described coordinate system as a reference.

### Third Modification

In the above-described second modification, the authentication processing is performed using the virtual mark not existing in a real environment, which is similar to the above-described first exemplary embodiment. In a third modification, as a substitute for the virtual mark disposed in the three-dimensional space, an object (hereinafter, referred to as a “real mark”) existing in the three-dimensional space, such as a robot travelling on the ground and a drone flying in the air, is used. In the third modification, to display the real mark on the display 112, it is necessary to capture an image of the real environment by the outer surface-side camera 114.

To determine whether the real mark is within the visual field of the outer surface-side camera 114 of the information processing apparatus 100-1, a position of the real mark and the position and orientation of the information processing apparatus 100-1 with a certain coordinate system as a reference are necessary, as described in the second modification. Thus, for example, in a manner similar to the second modification, the position of the real mark and the position and orientation of the information processing apparatus 100-1 are desirably measured and used in real time by using a motion capture system using an environment-installation camera. In a case where the real mark is an apparatus mounted with a camera, simultaneous localization and mapping (SLAM) with an image is desirably used. In other words, in the case where the real mark is an apparatus mounted with a camera, an environment map may be generated in advance using the SLAM with an image, and the position of the real mark and the position and orientation of the information processing apparatus 100-1 may be measured and used with a coordinate system of the map as a reference. Further, the position of the real mark is desirably measured using an image captured with the camera mounted on the real mark, and the position and orientation of the information processing apparatus 100-1 is desirably measured using an image captured by the outer surface-side camera 114 of the information processing apparatus 100-1.

Further, as a substitute for the real mark which varies in position, a still object may be used as the real mark. In a case of the still object, the position of the real mark with the above-described coordinate system as a reference is desirably measured in advance and used. The measurement is preferably performed using, for example, a total station.

In the third modification, for example, the outer surface-side camera 114 images the real mark disposed in the three-dimensional space, and the display 112 displays the real mark imaged by the outer surface-side camera 114. Then, the operation instruction unit 133 can be configured to issue an instruction, for example, to the authentication target person NT to perform an operation on the information processing apparatus 100-1 such that the real mark is continuously displayed on the display 112.

### Fourth Modification

In the above-described third modification, the method using the still object as the real mark is described. In the case of the still object, however, an operation of moving the information processing apparatus 100-1 so as to capture the real mark is easily performable, and accordingly, there is a possibility that spoofing will be successful. Therefore, a plurality of real marks may be prepared to increase difficulty of the operation of moving the real mark within the visual field of the outer surface-side camera 114 of the information processing apparatus 100-1.

For example, as advance preparation, the plurality of real marks may be discretely set on an indoor wall surface. When a track record that five or more real marks have entered the visual field of the outer surface-side camera 114 within 10 seconds during the authentication processing, it may be determined that spoofing is not performed. In this case, the operation instruction unit 133 can be configured to issue an instruction, for example, to the authentication target person NT to perform an operation on the information processing apparatus 100-1 such that each of the plurality of real marks is displayed on the display 112 one or more times within a predetermined time.

For example, restriction may be set to an order of the real marks that enter the visual field of the outer surface-side camera 114, and only when the real marks enter the visual field of the outer surface-side camera 114 in a specific order, it may be determined that spoofing is not performed. In this case, the operation instruction unit 133 can issue an instruction, for example, to the authentication target person NT to perform an operation on the information processing apparatus 100-1 such that the plurality of real marks is displayed on the display 112 in a predetermined order.

### Fifth Modification

In the above-described second exemplary embodiment, the example in which the operation instruction to “move to specific destination (1711)” from the current position 1712 of the information processing apparatus 100-2 is issued during the authentication processing is described. The present disclosure is not limited to such a configuration. For example, the operation instruction unit 133 may issue an operation instruction to cause the information processing apparatus 100-2 to “pass through specific area”. In this case, for example, in the information processing apparatus 100-2, as advance preparation, a three-dimensional area in a specific space is set as the specific area. The operation authentication unit 136 analyzes the position and orientation of the information processing apparatus 100-2 stored in step S104 of FIG. 4 and performs the operation authentication based on whether the information processing apparatus 100-2 has entered, from an outside of the specific area, the specific area once, and then has exited the specific area.

In addition, in the above-described second exemplary embodiment, the position and orientation measurement unit 132 measures the absolute position and orientation of the information processing apparatus 100-2 with one coordinate system as a reference; however, the present disclosure is not limited to such a configuration. For example, the position and orientation measurement unit 132 may measure a relative position and orientation of the information processing apparatus 100-2 in a manner similar to the above-described first exemplary embodiment. The destination or the specific area is desirably automatically set to a position near an initial value that is the position and orientation of the information processing apparatus 100-2 at the time of starting the authentication processing.

### Sixth Modification

In the second exemplary embodiment and the fifth modification described above, it is necessary for the authentication target person NT to move from the initial position while holding the information processing apparatus 100-2. Thus, in a case where moving means of the authentication target person NT is assumed to be walking, a fact that the authentication target person NT is walking while moving may be added to information for making a determination of the operation authentication processing in order to enhance reliability of the operation authentication processing. For example, in step S107 of FIG. 4, the operation authentication unit 136 performs determination on whether the authentication target person NT is walking by analyzing data such as an acceleration and an angular velocity acquired from the sensor 123 that is a detection unit. In a case where it is detected that the authentication target person NT is not walking in a predetermined section, the operation authentication unit 136 determines that the operation authentication has failed, and the processing proceeds to step S109 of FIG. 4. As the above-described predetermined section, a section from the initial position of the authentication target person NT holding the information processing apparatus 100-2 to the destination, or a section in a predetermined area through which the authentication target person NT holding the information processing apparatus 100-2 passes is suitably applied.

### Seventh Modification

In the first exemplary embodiment, the second exemplary embodiment, and the fifth modification described above, the operation instructions to “move apparatus to continuously capture specific mark”, to “move to specific destination”, and to “pass through specific area” are described as examples. However, in the present disclosure, another operation instruction may be issued. As the operation instruction, for example, an operation instruction to “walk straight ahead” or to “walk around a circle” may be issued. In this case, for example, in step S107 of FIG. 4, data on the acceleration and the angular velocity acquired from the sensor 123 and data on the position and orientation of an information processing apparatus 100 measured in step S104 are analyzed by pedestrian dead reckoning (PDR).

Then, the operation authentication in step S107 of FIG. 4 may be performed by determining whether the authentication target person NT has walked straight ahead or whether a track of the authentication target person NT walking has a closed loop.

### Eighth Modification

In the first exemplary embodiment and the second exemplary embodiment described above, the face authentication processing is repeatedly performed in step S105 of FIG. 4. In addition, in step S106 of FIG. 4, success/failure of the face authentication is determined based on a result of the face authentication processed in step S105.

However, in a case where information processing performance of the information processing apparatus 100 is low, it may be difficult to perform the face authentication processing in step S105 of FIG. 4. Thus, alternatively, only storage of the face image may be performed in step S105 of FIG. 4, and in step S106, the face authentication processing may be performed using the face image stored in step S105. For example, processing similar to the processing in step S106 in the above-described first exemplary embodiment is desirably performed using results obtained by performing the face authentication processing on all stored face images. To further reduce a calculation amount, results obtained by performing the face authentication processing on some face images selected from the stored face images may be used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-018130, filed Feb. 8, 2024, which is hereby incorporated by reference herein in its entirety.

What is claimed is:

1. An information processing apparatus that performs authentication of a target person, the information processing apparatus comprising:
at least one memory storing instructions; and
at least one processor that, upon execution of the stored instructions, causes the information processing apparatus to function as:
an acquisition unit that acquires a face image of the target person;
a face authentication unit that performs face authentication of the target person by using the face image;
an operation instruction unit that issues an instruction to the target person to perform an operation while holding the information processing apparatus;
an operation authentication unit that performs operation authentication of the target person based on the operation being performed according to the issued instruction and an actual operation of the information processing apparatus, including positional movement of the information processing apparatus; and
a determination unit that determines that the authentication of the target person has succeeded when the face authentication has succeeded and the operation authentication has succeeded, and determines that the authentication of the target person has failed when at least one of the face authentication and the operation authentication has failed.

2. The information processing apparatus according to claim 1, wherein, it is determined that a spoofing action of spoofing the target person has been performed when the face authentication has succeeded but the operation authentication has failed.

3. The information processing apparatus according to claim 1, wherein it is determined that the operation authentication has succeeded when the operation according to the issued instruction and the actual operation of the information processing apparatus match each other.

4. The information processing apparatus according to claim 1,
wherein execution of the stored instructions further configures the at least one processor to function as a measurement unit that measures a position and orientation of the information processing apparatus, and
wherein the actual operation of the information processing apparatus is detected based on the measured position and orientation of the information processing apparatus.

5. The information processing apparatus according to claim 4, wherein measurement of the position and orientation of the information processing apparatus and the face authentication are processed in parallel.

6. The information processing apparatus according to claim 4, wherein, after the measurement of the position and orientation of the information processing apparatus is performed, the face authentication is performed.

7. The information processing apparatus according to claim 4, wherein a relative position and orientation of the information processing apparatus is measured with an initial position and orientation of the information processing apparatus as a reference.

8. The information processing apparatus according to claim 4, wherein an absolute position and orientation of the information processing apparatus is measured with one coordinate system as a reference.

9. The information processing apparatus according to claim 1,
wherein execution of the stored instructions further configures the at least one processor to function as a display unit that causes display of a mark based on a position and orientation of the information processing apparatus, and
wherein an instruction is issued to the target person to perform the operation on the information processing apparatus to cause the mark to be continuously displayed on the display unit.

10. The information processing apparatus according to claim 9, wherein the mark is a mark based on a virtual mark or a real mark disposed in a three-dimensional space.

11. The information processing apparatus according to claim 9, further comprising a camera,
wherein the mark is a mark based on a real mark disposed in a three-dimensional space,
wherein the camera images the real mark,
wherein the real mark imaged by the camera is caused to be displayed on the display unit, and
wherein an instruction is issued to the target person to perform the operation on the information processing apparatus to cause the real mark to be continuously displayed on the display unit.

12. The information processing apparatus according to claim 11,
wherein a plurality of real marks is provided, and
wherein the operation instruction unit issues an instruction to the target person to perform the operation on the information processing apparatus to cause each of the plurality of real marks to be displayed on the display unit one or more times within a predetermined time.

13. The information processing apparatus according to claim 11,
wherein a plurality of real marks is provided, and
wherein the operation instruction unit issues an instruction to the target person to perform the operation on the information processing apparatus to cause the plurality of real marks to be displayed on the display unit in a predetermined order.

14. The information processing apparatus according to claim 9, wherein the display unit causes display of a combined image obtained by combining a virtual environment and the mark by using virtual reality (VR).

15. The information processing apparatus according to claim 9, further comprising a camera that images a real environment,
wherein the display unit causes display of a combined image obtained by combining the real environment imaged by the camera and the mark by using augmented reality (AR).

16. The information processing apparatus according to claim 1, wherein execution of the stored instructions further configures the at least one processor to function as a display unit that causes display of a current position of the information processing apparatus and a destination on the display unit,
wherein the operation instruction unit issues an instruction to the target person to perform the operation to move the information processing apparatus to the destination.

17. The information processing apparatus according to claim 1, wherein the operation instruction unit issues the instruction to the target person to perform the operation to cause the information processing apparatus to pass through a specific area.

18. The information processing apparatus according to claim 1,
wherein execution of the stored instructions further configures the at least one processor to function as a detection unit that detects whether the target person holding the information processing apparatus is walking, and
wherein the operation authentication unit determines that the operation authentication has failed when it is detected that the target person is not walking.

19. A method of controlling an information processing apparatus that performs authentication of an target person, the method comprising:
acquiring a face image of the target person;
performing face authentication of the target person by using the face image;
issuing an instruction to the target person to perform an operation while holding the information processing apparatus;
performing operation authentication of the target person based on the operation being performed according to the issued instruction and an actual operation of the information processing apparatus, including positional movement of the information processing apparatus; and
determining that the authentication of the target person has succeeded when the face authentication has succeeded and the operation authentication has succeeded, and determining that the authentication of the target person has failed when at least one of the face authentication and the operation authentication has failed.

20. A non-transitory computer-readable storage medium storing computer-executable instructions for causing a computer to execute a method comprising:
acquiring a face image of the target person;
performing face authentication of the target person by using the face image;
issuing an instruction to the target person to perform an operation while holding the information processing apparatus;
performing operation authentication of the target person based on the operation being performed according to the issued instruction and an actual operation of the information processing apparatus, including positional movement of the information processing apparatus; and
determining that the authentication of the target person has succeeded when the face authentication has succeeded and the operation authentication has succeeded, and determining that the authentication of the target person has failed when at least one of the face authentication and the operation authentication has failed.
